(19) United States
(12) Patent Application Publication
(10) Pub. No.: US 2026/0222963 A1
(43) Pub. Date: Jul. 30, 2026

(54) BIT RATE SELECTION IN A WIRELESS COMMUNICATIONS SYSTEM

(71) Applicant: QUALCOMM Incorporated, San Diego, CA (US)

(72) Inventors: Diana MAAMARI, San Diego, CA (US); Mickael MONDET, Louannec (FR); Hyun Yong LEE, San Diego, CA (US); Aziz GHOLMIEH, Del Mar, CA (US); Prasada Veera Reddy KADIRI, San Diego, CA (US)

(21) Appl. No.: 19/037,822

(22) Filed: Jan. 27, 2025

(51) Int. Cl. H04W 40/12; H04W 28/02; H04W 28/22

(52) U.S. Cl. CPC H04W 40/12; H04W 28/0268; H04W 28/22

(57) ABSTRACT

Methods, systems, and devices for wireless communication are described. A device may receive an indication of a first recommended bit rate for a first communication path for the device, the first communication path associated with a first network entity. The device may receive an indication of a second recommended bit rate for the device, the second communication path associated with a second communication path for the first network entity or a second network entity. The device may transmit, at a bit rate that is based at least in part on a combination of the first recommended bit rate and the second recommended bit rate, data associated with an application executed by the device.

### TECHNICAL FIELD

The following relates to wireless communication, including bit rate selection in a wireless communications system.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

Devices in a wireless system may communicate using various bit rates. Techniques for improving bit rate selection may be desired.

### SUMMARY

The systems, methods, and devices of this disclosure each have several innovative aspects, no single one of which is solely responsible for the desirable attributes disclosed herein.

A method for wireless communications by a device is described. The method may include receiving an indication of a first recommended bit rate for a first communication path for the device, the first communication path associated with a first network entity, receiving an indication of a second recommended bit rate for a second communication path for the device, the second communication path associated with the first network entity or a second network entity, and transmitting, at a bit rate that is based on a combination of the first recommended bit rate and the second recommended bit rate, data associated with an application executed by the device.

A device for wireless communications is described. The device may include one or more memories storing processor executable code, and one or more processors coupled with (e.g., operatively, communicatively, functionally, electronically, or electrically) the one or more memories. The one or more processors may individually or collectively be operable to execute the code (e.g., directly, indirectly, after pre-processing, without pre-processing) to cause the device to receive an indication of a first recommended bit rate for a first communication path for the device, the first communication path associated with a first network entity, receive an indication of a second recommended bit rate for a second communication path for the device, the second communication path associated with the first network entity or a second network entity, and transmit, at a bit rate that is based on a combination of the first recommended bit rate and the second recommended bit rate, data associated with an application executed by the device.

Another device for wireless communications is described. The device may include means for receiving an indication of a first recommended bit rate for a first communication path for the device, the first communication path associated with a first network entity, means for receiving an indication of a second recommended bit rate for a second communication path for the device, the second communication path associated with the first network entity or a second network entity, and means for transmitting, at a bit rate that is based on a combination of the first recommended bit rate and the second recommended bit rate, data associated with an application executed by the device.

A non-transitory computer-readable medium storing code for wireless communications is described. The code may include instructions executable by one or more processors (e.g., directly, indirectly, after pre-processing, without pre-processing) to receive an indication of a first recommended bit rate for a first communication path for the device, the first communication path associated with a first network entity, receive an indication of a second recommended bit rate for a second communication path for the device, the second communication path associated with the first network entity or a second network entity, and transmit, at a bit rate that is based on a combination of the first recommended bit rate and the second recommended bit rate, data associated with an application executed by the device.

Some examples of the method, devices, and non-transitory computer-readable medium described herein may further include operations, features, means, or instructions for transmitting the data at the bit rate includes transmitting one subset of the data at a second bit rate over a third communication path between the device and a user equipment (UE), the second bit rate based on the second recommended bit rate.

Some examples of the method, devices, and non-transitory computer-readable medium described herein may further include operations, features, means, or instructions for transmitting the data at the bit rate further includes transmitting another subset of the data at a first bit rate over the first communication path for the first network entity, the first bit rate based on the first recommended bit rate and the bit rate includes a combination of the first bit rate and the second bit rate.

Some examples of the method, devices, and non-transitory computer-readable medium described herein may further include operations, features, means, or instructions for determining that the first recommended bit rate may be for the first communication path based on a first identifier associated with the indication of the first recommended bit rate and determining that the second recommended bit rate may be for the second communication path based on a second identifier associated with the indication of the second recommended bit rate.

Some examples of the method, devices, and non-transitory computer-readable medium described herein may further include operations, features, means, or instructions for determining that the first recommended bit rate may be for the first communication path based on a bit associated with the indication of the first recommended bit rate.

In some examples of the method, devices, and non-transitory computer-readable medium described herein, the indication of the first recommended bit rate and the indication of the second recommended bit rate may be received by the device from the first network entity.

In some examples of the method, devices, and non-transitory computer-readable medium described herein, the indication of the first recommended bit rate may be received by the device from the first network entity and the indication of the second recommended bit rate may be received by the device from the UE.

Some examples of the method, devices, and non-transitory computer-readable medium described herein may further include operations, features, means, or instructions for transmitting a request for the second recommended bit rate based on the UE acting as a relay, between the device and the first network entity, for data associated with the application.

In some examples of the method, devices, and non-transitory computer-readable medium described herein, the first recommended bit rate and the second recommended bit rate may be both included in a set of recommended bit rates that may be each associated with a respective index from among a set of respective indices, the indication of the first recommended bit rate may be a first index from among the set of respective indices, and the indication of the second recommended bit rate may be a second index from among the set of respective indices.

In some examples of the method, devices, and non-transitory computer-readable medium described herein, receiving the indication of the first recommended bit rate and receiving the indication of the second recommended bit rate may include operations, features, means, or instructions for receiving a single index associated with both the first recommended bit rate and the second recommended bit rate.

In some examples of the method, devices, and non-transitory computer-readable medium described herein, the indication of the first recommended bit rate may be included in a first message and the indication of the second recommended bit rate may be included in a second message.

In some examples of the method, devices, and non-transitory computer-readable medium described herein, the indication of the first recommended bit rate and the indication of the second recommended bit rate may be included in a same message.

In some examples of the method, devices, and non-transitory computer-readable medium described herein, the device may be a server and the first communication path may be between a first UE and the first network entity, the second communication path may be between a second UE and the first network entity, and the data may be transmitted at the bit rate over a third communication path between the server and the first network entity.

Some examples of the method, devices, and non-transitory computer-readable medium described herein may further include operations, features, means, or instructions for selecting a codec rate for the application based on the combination of the first recommended bit rate and the second recommended bit rate, where the bit rate may be in accordance with the codec rate.

In some examples of the method, devices, and non-transitory computer-readable medium described herein, the device may be a UE and the first communication path may be between the UE and a first transmission reception point (TRP) associated with the first network entity and the second communication path may be between the UE and a second TRP associated with the first network entity or the second network entity.

In some examples of the method, devices, and non-transitory computer-readable medium described herein, the device may be a UE and the first communication path may be via a first beam between the UE and the first network entity and the second communication path may be via a second beam between the UE and the first network entity or the second network entity.

Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 shows an example of a wireless communications system that supports bit rate selection in a wireless communications system in accordance with one or more aspects of the present disclosure.

FIG. 2 shows an example of a wireless communications system that supports bit rate selection in a wireless communications system in accordance with one or more aspects of the present disclosure.

FIG. 3 shows an example of a process flow that supports bit rate selection in a wireless communications system in accordance with one or more aspects of the present disclosure.

FIGS. 4 and 5 show block diagrams of devices that support bit rate selection in a wireless communications system in accordance with one or more aspects of the present disclosure.

FIG. 6 shows a block diagram of a communications manager that supports bit rate selection in a wireless communications system in accordance with one or more aspects of the present disclosure.

FIG. 7 shows a diagram of a system including a device that supports bit rate selection in a wireless communications system in accordance with one or more aspects of the present disclosure.

FIG. 8 shows a flowchart illustrating methods that support bit rate selection in a wireless communications system in accordance with one or more aspects of the present disclosure.

### DETAILED DESCRIPTION

In some cases, a first user equipment (UE) in a wireless communications system may use a second UE to relay for information between the first UE and a network entity. Such a scheme may allow the first UE to achieve performance metrics that the first UE is otherwise unable to achieve acting alone. So, in addition to some data being exchanged directly between the first UE and the network entity using a direct communication path (referred to as the anchor communication path) between the first UE and the network entity, additional data may be exchanged indirectly by routing the additional data from the first UE to the network entity through the second UE (e.g., via multipath relay). A communication path may include one or more communication links. In an uplink example, the second UE may receive the additional data over a side communication path between the first UE and the second UE and may transmit the additional data to the network entity over a direct communication path (referred to as the cooperative communication path) between the second UE and the network entity.

The first UE may transmit over the anchor communication path using a first bit rate that is based on an uplink recommended bit rate (RBR) for the anchor communication path and may transmit over the side communication path between the two UEs using a second bit rate. But the first bit rate and the second bit rate may not account for the uplink RBR for the cooperative communication path, which may reduce the efficiency, reliability, or both, of communications between the first UE and the network entity. According to the techniques described herein, an indication of the RBR for the cooperative communication path may be provided to the first UE so that the first UE can use the RBR of the cooperative communication path as a basis for selecting the bit rate of the anchor communication path, the bit rate of the side communication path, or both.

In some examples, the techniques described herein may be extended to the downlink. For example, the downlink RBR for the cooperative communication path may be provided to a server so that the server can use the downlink RBR for the cooperative communication path as a basis for selecting the bit rate for a downlink communication path between the server and the network entity.

In some examples, the techniques described herein may be extended to a multi-transmission-reception point (multi-TRP) scenario in which the first UE has a first communication path with a first TRP and a second communication path with a second TRP. In such a scenario, the first TRP may indicate the RBRs for both communication paths so that the UE can select bit rates for the communication path based on both RBRs.

In some examples, the techniques described herein may be extended to a multi-beam scenario in which the UE is communicating with one or more network entities using multiple beams. In such a scenario, the RBRs for the communication paths associated with the beams may be indicated to the UE so that the UE can select bit rates for the communication paths based on both RBRs.

Aspects of the disclosure are initially described in the context of wireless communications systems. Additional aspects of the disclosure are further illustrated by and described with reference to apparatus diagrams, system diagrams, and flowcharts that relate to bit rate selection in a wireless communications system.

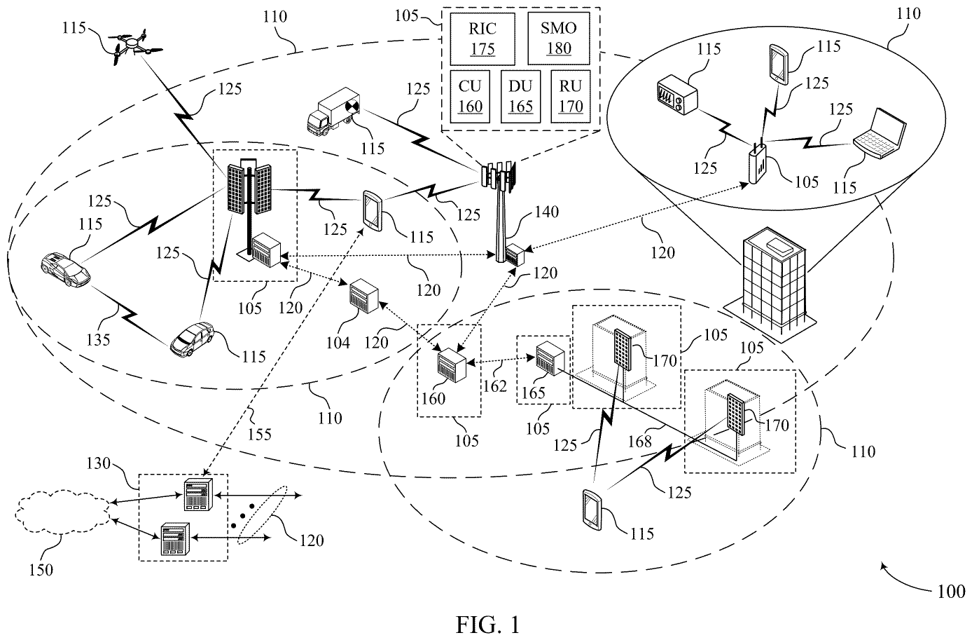

FIG. 1 shows an example of a wireless communications system 100 that supports bit rate selection in a wireless communications system in accordance with one or more aspects of the present disclosure. The wireless communications system 100 may include one or more devices, such as one or more network devices (e.g., network entities 105), one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via communication link(s) 125 (e.g., a radio frequency (RF) access link). For example, a network entity 105 may support a coverage area 110 (e.g., a geographic coverage area) over which the UEs 115 and the network entity 105 may establish the communication link(s) 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices in the wireless communications system 100 (e.g., other wireless communication devices, including UEs 115 or network entities 105), as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with a core network 130, or with one another, or both. For example, network entities 105 may communicate with the core network 130 via backhaul communication link(s) 120 (e.g., in accordance with an S1, N2, N3, or other interface protocol). In some examples, network entities 105 may communicate with one another via backhaul communication link(s) 120 (e.g., in accordance with an X2, Xn, or other interface protocol) either directly (e.g., directly between network entities 105) or indirectly (e.g., via the core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication link(s) 120, midhaul communication links 162, or fronthaul communication links 168 may be or include one or more wired links (e.g., an electrical link, an optical fiber link) or one or more wireless links (e.g., a radio link, a wireless optical link), among other examples or various combinations thereof. A UE 115 may communicate with the core network 130 via a communication link 155.

One or more of the network entities 105 or network equipment described herein may include or may be referred to as a base station 140 (e.g., a base transceiver station, a radio base station, an NR base station, an access point, a radio transceiver, a NodeB, an eNodeB (eNB), a next-generation NodeB or giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within one network entity (e.g., a network entity 105 or a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among multiple network entities (e.g., network entities 105), such as an integrated access and backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU), such as a CU 160, a distributed unit (DU), such as a DU 165, a radio unit (RU), such as an RU 170, a RAN Intelligent Controller (RIC), such as an RIC 175 (e.g., a Near-Real Time RIC (Near-RT RIC), a Non-Real Time RIC (Non-RT RIC)), a Service Management and Orchestration (SMO) system, such as an SMO system 180, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more of the network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, or any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaptation protocol (SDAP), Packet Data Convergence Protocol (PDCP)). The CU 160 (e.g., one or more CUs) may be connected to a DU 165 (e.g., one or more DUs) or an RU 170 (e.g., one or more RUs), or some combination thereof, and the DUs 165, RUs 170, or both may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or multiple different RUs, such as an RU 170). In some cases, a functional split between a CU 160 and a DU 165 or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to a DU 165 via a midhaul communication link 162 (e.g., F1, F1-c, F1-u), and a DU 165 may be connected to an RU 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities (e.g., one or more of the network entities 105) that are in communication via such communication links.

In some wireless communications systems (e.g., the wireless communications system 100), infrastructure and spectral resources for radio access may support wireless backhaul link capabilities to supplement wired backhaul connections, providing an IAB network architecture (e.g., to a core network 130). In some cases, in an IAB network, one or more of the network entities 105 (e.g., network entities 105 or IAB node(s) 104) may be partially controlled by each other. The IAB node(s) 104 may be referred to as a donor entity or an IAB donor. A DU 165 or an RU 170 may be partially controlled by a CU 160 associated with a network entity 105 or base station 140 (such as a donor network entity or a donor base station). The one or more donor entities (e.g., IAB donors) may be in communication with one or more additional devices (e.g., IAB node(s) 104) via supported access and backhaul links (e.g., backhaul communication link(s) 120). IAB node(s) 104 may include an IAB mobile termination (IAB-MT) controlled (e.g., scheduled) by one or more DUs (e.g., DUs 165) of a coupled IAB donor. An IAB-MT may be equipped with an independent set of antennas for relay of communications with UEs 115 or may share the same antennas (e.g., of an RU 170) of IAB node(s) 104 used for access via the DU 165 of the IAB node(s) 104 (e.g., referred to as virtual IAB-MT (vIAB-MT)). In some examples, the IAB node(s) 104 may include one or more DUs (e.g., DUs 165) that support communication links with additional entities (e.g., IAB node(s) 104, UEs 115) within the relay chain or configuration of the access network (e.g., downstream). In such cases, one or more components of the disaggregated RAN architecture (e.g., the IAB node(s) 104 or components of the IAB node(s) 104) may be configured to operate according to the techniques described herein.

In the case of the techniques described herein applied in the context of a disaggregated RAN architecture, one or more components of the disaggregated RAN architecture may be configured to support bit rate selection in a wireless communications system as described herein. For example, some operations described as being performed by a UE 115 or a network entity 105 (e.g., a base station 140) may additionally, or alternatively, be performed by one or more components of the disaggregated RAN architecture (e.g., components such as an IAB node, a DU 165, a CU 160, an RU 170, an RIC 175, an SMO system 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a multimedia/entertainment device (e.g., a radio, a MP3 player, or a video device), a camera, a gaming device, a navigation/positioning device (e.g., GNSS (global navigation satellite system) devices based on, for example, GPS (global positioning system), Beidou, GLONASS, or Galileo, or a terrestrial-based device), a tablet computer, a laptop computer, a netbook, a smartbook, a personal computer, a smart device, a wearable device (e.g., a smart watch, smart clothing, smart glasses, virtual reality goggles, a smart wristband, smart jewelry (e.g., a smart ring, a smart bracelet)), a drone, a robot/robotic device, a vehicle, a vehicular device, a meter (e.g., parking meter, electric meter, gas meter, water meter), a monitor, a gas pump, an appliance (e.g., kitchen appliance, washing machine, dryer), a location tag, a medical/healthcare device, an implant, a sensor/actuator, a display, or any other suitable device configured to communicate via a wireless or wired medium. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, vehicles, or meters, among other examples.

The UEs 115 described herein may be able to communicate with various types of devices, such as UEs 115 that may sometimes operate as relays, as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via the communication link(s) 125 (e.g., one or more access links) using resources associated with one or more carriers. The term “carrier” may refer to a set of RF spectrum resources having a defined PHY layer structure for supporting the communication link(s) 125. For example, a carrier used for the communication link(s) 125 may include a portion of an RF spectrum band (e.g., a bandwidth part (BWP)) that is operated according to one or more PHY layer channels for a given RAT (e.g., LTE, LTE-A, LTE-A Pro, NR). Each PHY layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities, such as one or more of the network entities 105).

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems, such as the wireless communications system 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (sTTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to UEs 115 (e.g., one or more UEs) or may include UE-specific search space sets for sending control information to a UE 115 (e.g., a specific UE).

In some examples, a network entity 105 (e.g., a base station 140, an RU 170) may be movable and therefore provide communication coverage for a moving coverage area, such as the coverage area 110. In some examples, coverage areas 110 (e.g., different coverage areas) associated with different technologies may overlap, but the coverage areas 110 (e.g., different coverage areas) may be supported by the same network entity (e.g., a network entity 105). In some other examples, overlapping coverage areas, such as a coverage area 110, associated with different technologies may be supported by different network entities (e.g., the network entities 105). The wireless communications system 100 may include, for example, a heterogeneous network in which different types of the network entities 105 support communications for coverage areas 110 (e.g., different coverage areas) using the same or different RATs.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs (e.g., one or more of the UEs 115) via a device-to-device (D2D) communication link, such as a D2D communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to one or more of the UEs 115 in the group. In some examples, a network entity 105 may facilitate the scheduling of resources for D2D communications. In some other examples, D2D communications may be carried out between the UEs 115 without an involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than one hundred kilometers) compared to communications using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) RAT, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

The network entities 105 or the UEs 115 may use MIMO communications to exploit multipath signal propagation and increase spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry information associated with the same data stream (e.g., the same codeword) or different data streams (e.g., different codewords). Different spatial layers may be associated with different antenna ports used for channel measurement and reporting. MIMO techniques include single-user MIMO (SU-MIMO), for which multiple spatial layers are transmitted to the same receiving device, and multiple-user MIMO (MU-MIMO), for which multiple spatial layers are transmitted to multiple devices.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A network entity 105 or a UE 115 may use beam sweeping techniques as part of beamforming operations. For example, a network entity 105 (e.g., a base station 140, an RU 170) may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a network entity 105 multiple times along different directions. For example, the network entity 105 may transmit a signal according to different beamforming weight sets associated with different directions of transmission. Transmissions along different beam directions may be used to identify (e.g., by a transmitting device, such as a network entity 105, or by a receiving device, such as a UE 115) a beam direction for later transmission or reception by the network entity 105.

Some signals, such as data signals associated with a particular receiving device, may be transmitted by a transmitting device (e.g., a network entity 105 or a UE 115) along a single beam direction (e.g., a direction associated with the receiving device, such as another network entity 105 or UE 115). In some examples, the beam direction associated with transmissions along a single beam direction may be determined based on a signal that was transmitted along one or more beam directions. For example, a UE 115 may receive one or more of the signals transmitted by the network entity 105 along different directions and may report to the network entity 105 an indication of the signal that the UE 115 received with a highest signal quality or an otherwise acceptable signal quality.

In some examples, transmissions by a device (e.g., by a network entity 105 or a UE 115) may be performed using multiple beam directions, and the device may use a combination of digital precoding or beamforming to generate a combined beam for transmission (e.g., from a network entity 105 to a UE 115). The UE 115 may report feedback that indicates precoding weights for one or more beam directions, and the feedback may correspond to a configured set of beams across a system bandwidth or one or more sub-bands. The network entity 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted along one or more directions by a network entity 105 (e.g., a base station 140, an RU 170), a UE 115 may employ similar techniques for transmitting signals multiple times along different directions (e.g., for identifying a beam direction for subsequent transmission or reception by the UE 115) or for transmitting a signal along a single direction (e.g., for transmitting data to a receiving device).

A receiving device (e.g., a UE 115) may perform reception operations in accordance with multiple receive configurations (e.g., directional listening) when receiving various signals from a transmitting device (e.g., a network entity 105), such as synchronization signals, reference signals, beam selection signals, or other control signals. For example, a receiving device may perform reception in accordance with multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned along a beam direction determined based on listening according to different receive configuration directions (e.g., a beam direction determined to have a highest signal strength, highest signal-to-noise ratio (SNR), or otherwise acceptable signal quality based on listening according to multiple beam directions).

In some cases, a first UE 115 may may communicate some data directly with the network entity 105 and may communicate other data indirectly through a second UE 115 that acts as a relay device. For example, the first UE 115 may communicate some data to the network entity 105 by transmitting the data to the network entity 105 over a direct communication path, referred to as the anchor communication path, between the first UE 115 and the network entity 105. The first UE 115 route additional data to the network entity 105 via the second UE 115, which has its own direct communication path, referred to as the cooperative communication path, with the network entity 105. Use of the second UE 115 may allow the first UE to improve various performance metrics.

The first UE 115 may use a first bit rate to communicate with the network entity 105 over the anchor communication path and may use a second bit rate to communicate with the second UE 115 over the side communication path. The first bit rate for the anchor communication path may be based on an RBR for the anchor communication path that is indicated to the first UE 115 by the network entity 105. But the UE 115 may be unaware of the RBR for the cooperative communication path, and so the second bit rate for the side communication path may be too high or too low for the RBR for the cooperative communication path. According to the techniques described herein, the RBR for the cooperative communication path may be indicated to the first UE 115 so that the first UE 115 can select the second bit rate for the side communication path based on RBR for the cooperative communication path.

In some examples, both RBRs (e.g., the RBR for the anchor communication path and the RBR for the cooperative communication path) may be indicated to a server so that the server can uses the RBRs as bases for selecting a downlink bit rate for a communication path between the server and the network entity 105.

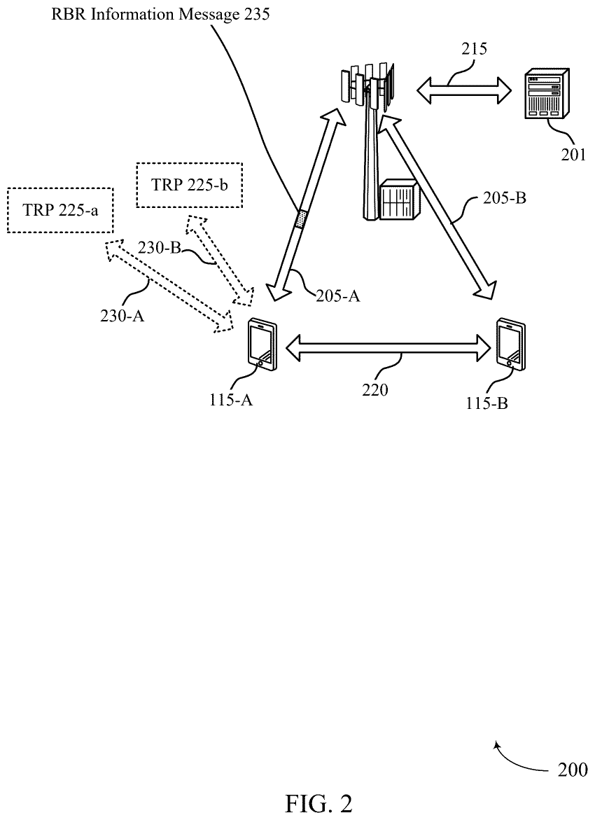

FIG. 2 shows an example of a wireless communications system 200 that supports bit rate selection in a wireless communications system in accordance with one or more aspects of the present disclosure. The wireless communications system 200 may include a network entity 105-a, which may be an example of a network entity 105 as described with reference to FIG. 1. The wireless communications system 200 may also include a UE 115-a and a UE 115-b, which may be examples of a UE 115 as described with reference to FIG. 1. According to the techniques described herein, the RBR for the cooperative communication path 205-b between be UE 115-b and the network entity 105-a may be indicated to a device (e.g., the UE 115-a, the server 201) so that the device can use the RBR as a basis for selecting a bit rate for one or more communication path (e.g., the side communication path 220, the anchor communication path 205-a, the communication path 215).

In some examples, data may be exchanged indirectly between the UE 115-a and the network entity 105-a by routing the data from the UE 115-a to the network entity 105-a through the UE 115-b (e.g., via a multi-path relay). In some cases, the UEs 115 each of which have their own separate connection (e.g., a Uu connection) with the network entity 105-a and are cooperating. The UE 115-a, which may have the application client, may split traffic in the uplink between the two connections. In some cases, the RAN, Access Stratum, base station or the core network (UPF, PCF, AF) is aware that the two UEs 115 are cooperating and splitting/steering/switching across the two connections (for downlink and uplink transmissions). In some examples, there can be multiple UEs 115 cooperating in uplink transmission of packets, packet data units, packet data unit sets, or bursts of same or different Quality-of-Service (QoS) flows. In some examples, the UEs 115 may share a common subscription profile and the network (RAN, UPF, AF, PCF) is aware that these UEs 115 are cooperating.

Although described with reference to two UEs 115, the techniques described herein may be implemented for any quantity of UEs 115 and any quantity of communication paths. A communication path may also be referred to as a communication link or other suitable terminology.

In some examples, the UE 115-a may execute an application and communicate data associated with the application directly with the network entity 105-a a. To increase performance, the UE 115-a may route some of the data to the network entity 105-a via the UE 115-b. Such a cooperative scheme may support small-form-factor (e.g., wearable) UEs, such as those that enable extended reality (XR) applications (e.g., smart watches, smart rings, smart glasses), as these types of UEs may have more limitations (e.g., limited antennas, limited power budgets, limited thermal budgets) compared to other UEs. So, on the uplink, some data (e.g., application data) may be communicated from the UE 115-a to the network entity 105-a over the anchor communication path 205-a. And additional data (e.g., additional application data) may be communicated from the UE 115-a to the UE 115-b over the side communication path 220, and then communicated from the UE 115-b to the network entity 105-a over the cooperative communication path 205-b.

The UE 115-a may select a first bit rate for the anchor communication path 205-a based on an RBR for the anchor communication path 205-a, referred to as the anchor path RBR. The anchor path RBR may be selected by the network entity 105-a (e.g., based on the congestion in the wireless communications system 200) and indicated to the UE 115-a in the RBR information message 235, which may be a MAC control element (MAC-CE) message. In some examples, UE 115-a may also use the cooperative path RBR as a basis for selecting the first bit rate for the anchor communication path 205-a (e.g., the UE 115-a may select the first bit rate based on a combination of the anchor path RBR and the cooperative path RBR).

To ensure that an appropriate bit rate is used for the side communication path 220, the UE 115-a may select a second bit rate for the side communication path 220 based on the RBR for the cooperative communication path 205-b, referred to as the cooperative path RBR. The cooperative path RBR may be indicated to the UE 115-a by the network entity 105-a or by the UE 115-b (which may receive the cooperative path RBR from the network entity 105-a). In some examples, the UE 115-a may also use the anchor path RBR as a basis for selecting the second bit rate for the cooperative communication path 205-b (e.g., the UE 115-a may select the second bit rate based on a combination of the anchor path RBR and the cooperative path RBR). The overall bit rate may be a combination of (e.g., the sum of) the bit rate for the anchor communication path 205-a and the bit rate for the side communication path 220. So, it may be said that the UE 115-a selects the overall bit rate based on the anchor path RBR and the cooperative path RBR.

After selecting the bit rates, the UE 115-a may communicate data over the communication paths using the bit rates. For example, the UE 115-a may communicate some data (e.g., application data) to the network entity 105-a at the first bit rate over the anchor communication path 205-a, and may communicate additional data (e.g., application data) to the UE 115-b at the second bit rate over the side communication path 220. The UE 115-b may relay the additional data to the network entity 105-a over the cooperative communication path 205-b at a third bit rate that is selected by the UE 115-b based on the cooperative path RBR.

In some examples, the UE 115-a may transmit a request for one or more RBRs. For example, the UE 115-a may transmit to the network entity 105-a a request for the anchor path RBR, the cooperative path RBR, or both. In some examples, the bit rates selected by the UE 115-a may be in accordance with a codec rate for the application, which may be selected based on a combination of the anchor path RBR and the cooperative path RBR.

The anchor path RBR and the cooperative path RBR may be indicated in the same RBR information message 235 (e.g., in a same MAC-CE message) or in different RBR information messages (e.g., in different MAC-CE messages). In either example, the RBRs may be distinguished by one or more identifiers (e.g., logical channel identifiers (LCIDs), UE identifiers).

The anchor path RBR and the cooperative path RBR may be indicated by the same index or by different indices. For example, a first index value may be associated with the anchor path RBR and a second index value may be associated with the cooperative path RBR. In such examples, the indices may be indices to a table that maps one RBR to each index. For example, the indices may be indices for Table 1, which maps n indices to n RBRs.

TABLE 1

| Index | RBR |
|---|---|
| 1 | RBR1 |
| 2 | RBR2 |
| 3 | RBR3 |
| . . . | . . . |
| n | RBRn |

Alternatively, a single index value may be associated with multiple RBRs, and one or more bits may indicate which RBR is for the UE 115-a or the UE 115-b. In such examples, the index may be an index to a table that maps multiple RBRs to each index. For example, the index may be an index for Table 2, which maps n indices to 2n RBRs. Such an implementation (using one index to indicate multiple RBRs) may support XR applications, which may have two different types of data (e.g., audio data and visual data) that are split between the UEs 115.

TABLE 2

| Index | First RBR | Second RBR |
|---|---|---|
| 1 | RBR1_1 | RBR2_1 |
| 2 | RBR1_2 | RBR2_2 |
| 3 | RBR1_3 | RBR2_3 |
| . . . | . . . | . . . |
| n | RBRn | RBR2n |

In some examples, the RBR signaling techniques may be extended to downlink scenarios. For example, the UE 115-a may be a client of an application executed by the server 201, and thus may receive data associated with the application from the network entity 105-a. The data may be communicated from the server 201 to the network entity 105-a using the communication path 215, and then may be communicated from the network entity 105-a to the UE 115-a directly (e.g., via the anchor communication path 205-a), indirectly (e.g., through the UE 115-b), or both. To ensure that the downlink bit rate used for communicating the data over the communication path 215 is appropriate for the downlink RBRs, the server 201 may use both the anchor path RBR and the cooperative path RBR to select the downlink bit rate for the communication path 215. The RBRs may be indicated to server by the network entity 105-a or by one or both UEs 115, among other possibilities.

In some examples, the RBR signaling techniques may be extended to multi-TRP scenarios. For example, the network entity 105-a may be associated with multiple TRPs: a first TRP 225-a and a second TRP 225-b. Each TRP 225 may have a communication path with the UE 115-a. For example, the first TRP 225-a may communicate with the UE 115-a over the communication path 230-a, and the second TRP 225-b may communicate with the UE 115-a over the communication path 230-b. Each communication path 230 may have an RBR selected by the network entity 105-a. In such examples, one TRP 225 may communicate the RBR for its communication path 230 as well as the RBR for other communication path of the other TRP 225. For example, the first TRP 225-a may transmit to the UE 115-a both the RBR for the communication path 230-a and the RBR for the communication path 230-b. Accordingly, the UE 115-a may select the bit rate for communication path 230-a based on the RBR for the communication path 230-a, the RBR for the communication path 230-b, or both. Similarly, the UE 115-a may select the bit rate for communication path 230-b based on the RBR for the communication path 230-a, the RBR for the communication path 230-b, or both.

In some examples, the RBR signaling techniques may be extended to multi-beam scenarios. For example, the UE 115-a may communicate over multiple paths, such as the communication path 205-a and a second communication link path that are associated with different beams. The communication path 205-a may be associated with a first beam and a second communication path may be associated with a second beam. In such an example, the communication path 205-a may be between the UE 115-a and the network entity 105-a, and the second communication path may be between the UE 115-a and either the network entity 105-a or a second network entity. The UE 115-a may select the bit rate for the communication path 205-a based on the RBR for the communication path 205-a as well as on the RBR for the second communication path. Similarly, the UE 115-a may select the bit rate for the second communication path based on the RBR for the second communication path as well as on the RBR for the communication path 205-a.

Thus, the RBR signaling techniques described herein may support the selection of bit rates for various communication paths in the wireless communications system 200.

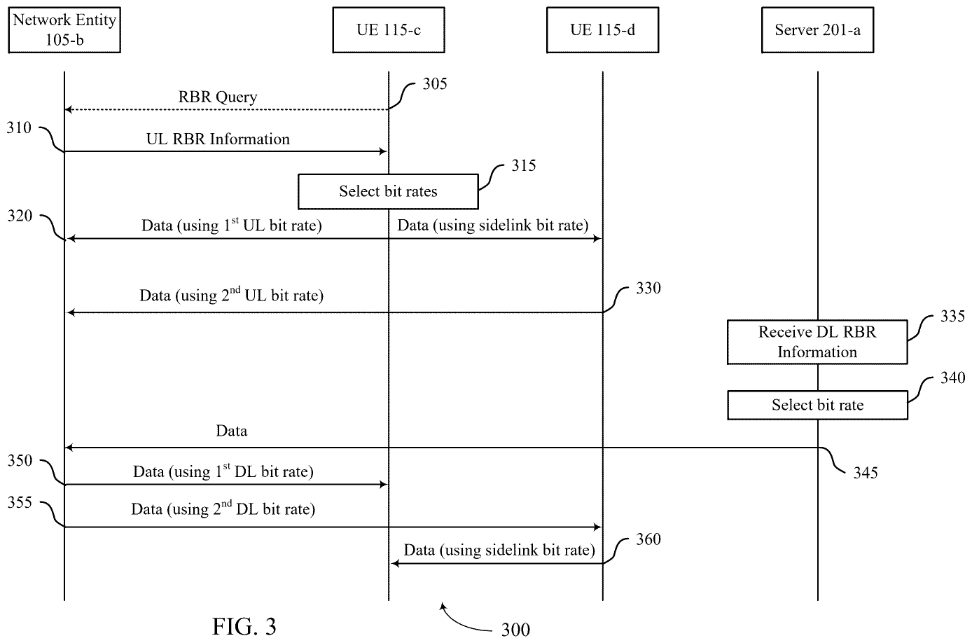

FIG. 3 shows an example of a process flow 300 that supports bit rate selection in a wireless communications system in accordance with one or more aspects of the present disclosure. The process flow 300 may be implemented by a network entity 105-b, a UE 115-c, a UE 115-d, and a server 201-a, which may be examples of the respective devices as described herein. The process flow 300 may support RBR signaling and bit rate selection in both the uplink direction and the downlink direction. In the uplink direction, the UE 115-c may execute an application and communicate data associated with the application to the network entity 105-b directly (e.g., via an anchor communication path between the UE 115-c and the network entity 105-b) and indirectly (e.g., via the UE 115-d). In the downlink direction, the UE 115-c may be a client of an application executed by the server 201-a and may receive data associated with the application from the network entity 105-b.

In some examples, the network entity 105-b may determine, before or after 305, that the UE 115-c and the UE 115-d are in a cooperative relationship as described herein, with the UE 115-d relaying information between the UE 115-c and the network entity 105-b. For example, the network entity 105-b may determine that the UE 115-c and the UE 115-d share a subscription profile. Or the cooperative relationship may be signaled to the network entity 105-b by the UE 115-c, the UE 115-d, or the server 201-a. The network entity 105-b may select RBRs for the anchor communication path and the cooperative communication path based on the UE 115-c and the UE 115-d being in the cooperative relationship.

At 305, the UE 115-c may transmit (e.g., over the anchor communication path) a request for RBR information to the network entity 105-b. The request may be for the anchor path RBR, the cooperative path RBR, or both.

At 310, the network entity 105-b may transmit RBR information to the UE 115-c. The RBR information may be transmitted based on (e.g., in response to) the request at 310. The RBR information may include an indication of the anchor path RBR, an indication of the cooperative path RBR, or both. In an alternative, the RBR information from the network entity 105-b may include the indication of the anchor path RBR and separate signaling from the UE 115-d may include the indication of the cooperative path RBR.

The indications of the RBRs may be included in a single message (e.g., a MAC-CE message) or different messages (e.g., multiple MAC-CE messages). A single index (e.g., from Table 1) may indicate both RBRs or separate indexes (e.g., from Table 2) may indicate the RBRs. If separate indexes are used, the RBRs may be distinguished based on one or more bits or identifiers included in the message(s). For example, the UE 115-c may determine that a first RBR is the anchor RBR based on a first identifier (or a bit value) associated with the indication of the first RBR; and the UE 115-c may determine that a second RBR is the cooperative RBR based on a second identifier (or bit value) associated with the indication of the second RBR. Alternatively, the UE 115-c may determine that the second RBR is the cooperative RBR based on the first RBR being the anchor RBR, or vice versa.

At 315, the UE 115-c may select one or more bit rates based on the RBR information. For example, the UE 115-c may select a first bit rate for the anchor communication path based on the anchor path RBR, the cooperative path RBR, or both. Similarly, the UE 115-c may select a second bit rate for the cooperative communication path based on the cooperative path RBR, the anchor path RBR, or both. In some examples, the first bit rate and the second bit rate may be in accordance with a codec bit rate for the application, which may be based on the combination of the anchor RBR and the cooperative RBR.

At 320, the UE 115-c may transmit some data (e.g., a first subset of the data from the application) to the network entity 105-b over the anchor communication path using the first bit rate. And the UE 115-c may transmit additional data (e.g., a second subset of the data from the application) to the UE 115-d over the side communication path using the second bit rate. Thus, the UE 115-c may transmit the data at an overall bit rate that is a combination (e.g., sum) of the first bit rate and the second bit rate. In some examples, the overall bit rate may be in accordance with the codec bit rate. At 330, the UE 115-d may transmit the second subset of packets to the network entity over the cooperative communication path using a bit rate that is based on the cooperative RBR.

Thus, the RBR signaling techniques described herein may support uplink bit rate selection by the UE 115-c.

At 335, the server 201 may receive downlink (DL) RBR information. The downlink RBR information may include an indication of the anchor path DL RBR, an indication of the cooperative path DL RBR, or both. The downlink RBR information may be received from the network entity 105-b, the UE 115-c, the UE 115-d, or a combination thereof.

At 340, the server 201 may select a downlink bit rate for the communication path between the server 201-a and the network entity 105-b. The downlink bit rate may be selected based on the anchor path DL RBR, the cooperative path DL RBR, or both. The downlink bit rate may be in accordance with the codec rate for the application, which may be based on the combination of the anchor path DL RBR and the cooperative path DL RBR.

At 345, the server 201-a may transmit to the network entity 105-b data associated with the application being executed by the server 201-a. The data may be transmitted at the downlink bit rate over the communication path between the server 201-a and the network entity 105-b.

At 350, the network entity 105-b may transmit some of the data (e.g., a first subset of the data) to the UE 115-c. The data may be transmitted to the UE 115-c at first DL bit rate that is based on the anchor path DL RBR. At 355, the network entity 105-b may transmit some of the data (e.g., a second subset of the data) to the UE 115-d. The data may be transmitted to the UE 115-d at a second DL bit rate that is based on the cooperative path DL RBR. At 360, the UE 115-d may transmit the data received at 355 to the UE 115-c.

Thus, the RBR signaling techniques described herein may support downlink bit rate selection by the server 201-a.

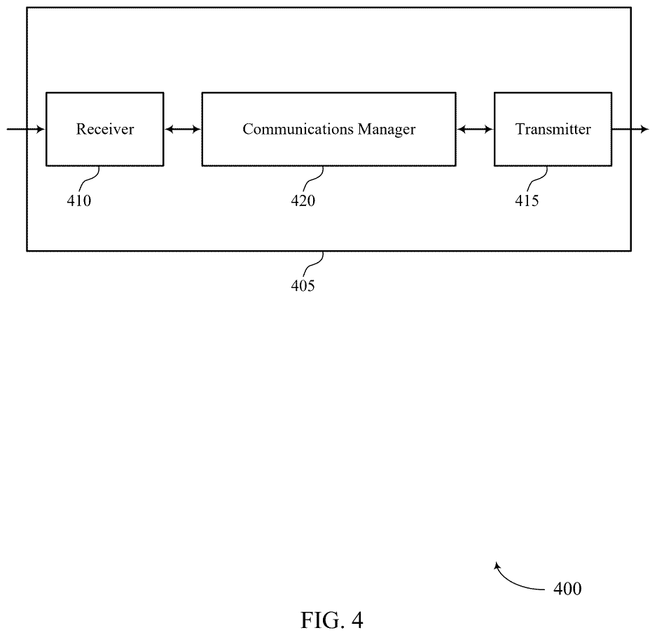

FIG. 4 shows a block diagram 400 of a device 405 that supports bit rate selection in a wireless communications system in accordance with one or more aspects of the present disclosure. The device 405 may be an example of aspects of a UE 115 as described herein. The device 405 may include a receiver 410, a transmitter 415, and a communications manager 420. The device 405, or one or more components of the device 405 (e.g., the receiver 410, the transmitter 415, the communications manager 420), may include at least one processor, which may be coupled with at least one memory, to, individually or collectively, support or enable the described techniques. Each of these components may be in communication with one another (e.g., via one or more buses).

The receiver 410 may provide a means for receiving information such as packets, user data, control information, or any combination thereof associated with various information channels (e.g., control channels, data channels, information channels related to bit rate selection in a wireless communications system). Information may be passed on to other components of the device 405. The receiver 410 may utilize a single antenna or a set of multiple antennas.

The transmitter 415 may provide a means for transmitting signals generated by other components of the device 405. For example, the transmitter 415 may transmit information such as packets, user data, control information, or any combination thereof associated with various information channels (e.g., control channels, data channels, information channels related to bit rate selection in a wireless communications system). In some examples, the transmitter 415 may be co-located with a receiver 410 in a transceiver module. The transmitter 415 may utilize a single antenna or a set of multiple antennas.

The communications manager 420, the receiver 410, the transmitter 415, or various combinations or components thereof may be examples of means for performing various aspects of bit rate selection in a wireless communications system as described herein. For example, the communications manager 420, the receiver 410, the transmitter 415, or various combinations or components thereof may be capable of performing one or more of the functions described herein.

In some examples, the communications manager 420, the receiver 410, the transmitter 415, or various combinations or components thereof may be implemented in hardware (e.g., in communications management circuitry). The hardware may include at least one of a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 420, the receiver 410, the transmitter 415, or various combinations or components thereof may be implemented in code (e.g., as communications management software) executed by at least one processor (e.g., referred to as a processor-executable code). If implemented in code executed by at least one processor, the functions of the communications manager 420, the receiver 410, the transmitter 415, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 420 may be configured to perform various operations (e.g., receiving, obtaining, monitoring, outputting, transmitting) using or otherwise in cooperation with the receiver 410, the transmitter 415, or both. For example, the communications manager 420 may receive information from the receiver 410, send information to the transmitter 415, or be integrated in combination with the receiver 410, the transmitter 415, or both to obtain information, output information, or perform various other operations as described herein.

The communications manager 420 may support wireless communications in accordance with examples as disclosed herein. For example, the communications manager 420 is capable of, configured to, or operable to support a means for receiving an indication of a first recommended bit rate for the device, the first communication path associated with a first communication path for a first network entity. The communications manager 420 is capable of, configured to, or operable to support a means for receiving an indication of a second recommended bit rate for the device, the second communication path associated with a second communication path for the first network entity or a second network entity. The communications manager 420 is capable of, configured to, or operable to support a means for transmitting, at a bit rate that is based on a combination of the first recommended bit rate and the second recommended bit rate, data associated with an application executed by the device.

By including or configuring the communications manager 420 in accordance with examples as described herein, the device 405 (e.g., at least one processor controlling or otherwise coupled with the receiver 410, the transmitter 415, the communications manager 420, or a combination thereof) may support techniques for more efficient utilization of communication resources.

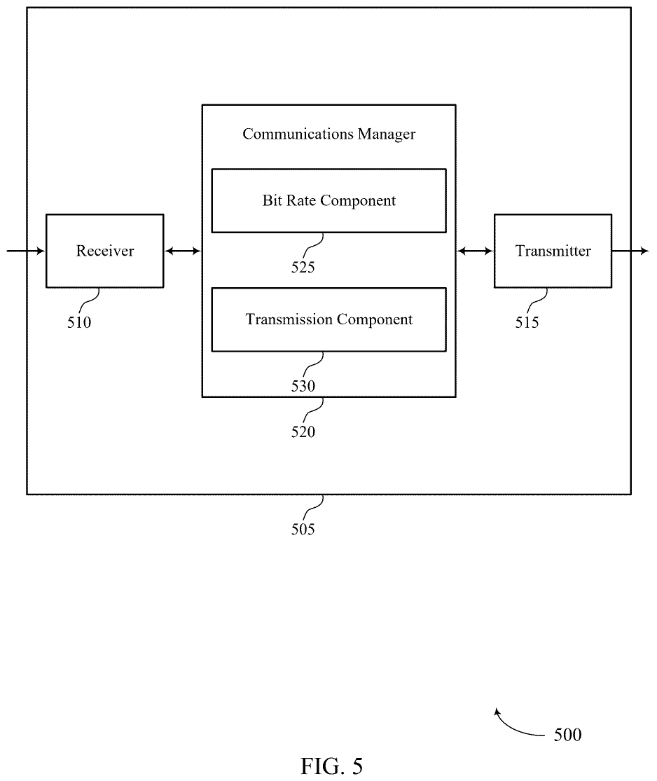

FIG. 5 shows a block diagram 500 of a device 505 that supports bit rate selection in a wireless communications system in accordance with one or more aspects of the present disclosure. The device 505 may be an example of aspects of a device 405 or a UE 115 as described herein. The device 505 may include a receiver 510, a transmitter 515, and a communications manager 520. The device 505, or one of more components of the device 505 (e.g., the receiver 510, the transmitter 515, the communications manager 520), may include at least one processor, which may be coupled with at least one memory, to support the described techniques. Each of these components may be in communication with one another (e.g., via one or more buses).

The receiver 510 may provide a means for receiving information such as packets, user data, control information, or any combination thereof associated with various information channels (e.g., control channels, data channels, information channels related to bit rate selection in a wireless communications system). Information may be passed on to other components of the device 505. The receiver 510 may utilize a single antenna or a set of multiple antennas.

The transmitter 515 may provide a means for transmitting signals generated by other components of the device 505. For example, the transmitter 515 may transmit information such as packets, user data, control information, or any combination thereof associated with various information channels (e.g., control channels, data channels, information channels related to bit rate selection in a wireless communications system). In some examples, the transmitter 515 may be co-located with a receiver 510 in a transceiver module. The transmitter 515 may utilize a single antenna or a set of multiple antennas.

The device 505, or various components thereof, may be an example of means for performing various aspects of bit rate selection in a wireless communications system as described herein. For example, the communications manager 520 may include a bit rate component 525 a transmission component 530, or any combination thereof. The communications manager 520 may be an example of aspects of a communications manager 420 as described herein. In some examples, the communications manager 520, or various components thereof, may be configured to perform various operations (e.g., receiving, obtaining, monitoring, outputting, transmitting) using or otherwise in cooperation with the receiver 510, the transmitter 515, or both. For example, the communications manager 520 may receive information from the receiver 510, send information to the transmitter 515, or be integrated in combination with the receiver 510, the transmitter 515, or both to obtain information, output information, or perform various other operations as described herein.

The communications manager 520 may support wireless communications in accordance with examples as disclosed herein. The bit rate component 525 is capable of, configured to, or operable to support a means for receiving an indication of a first recommended bit rate for the device, the first communication path associated with a first communication path for a first network entity. The bit rate component 525 is capable of, configured to, or operable to support a means for receiving an indication of a second recommended bit rate for the device, the second communication path associated with a second communication path for the first network entity or a second network entity. The transmission component 530 is capable of, configured to, or operable to support a means for transmitting, at a bit rate that is based on a combination of the first recommended bit rate and the second recommended bit rate, data associated with an application executed by the device.

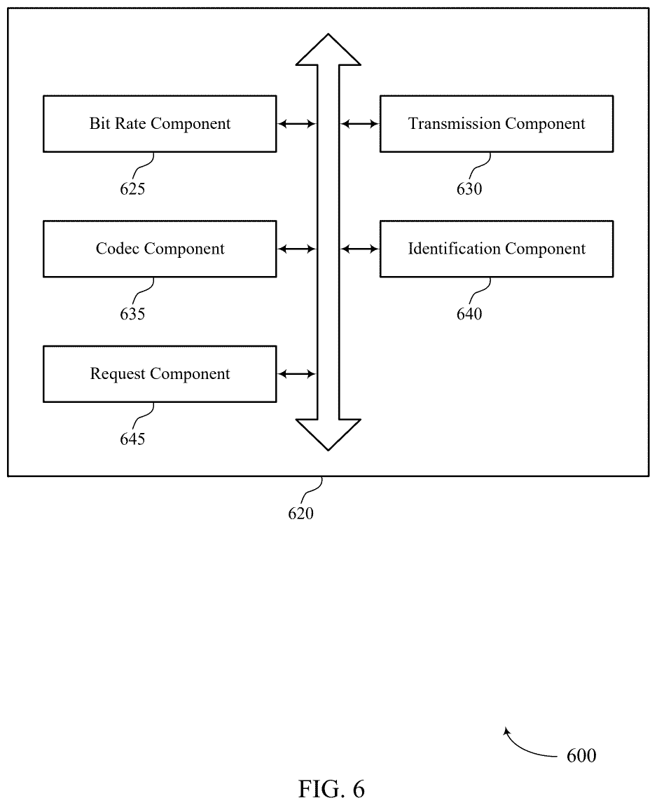

FIG. 6 shows a block diagram 600 of a communications manager 620 that supports bit rate selection in a wireless communications system in accordance with one or more aspects of the present disclosure. The communications manager 620 may be an example of aspects of a communications manager 420, a communications manager 520, or both, as described herein. The communications manager 620, or various components thereof, may be an example of means for performing various aspects of bit rate selection in a wireless communications system as described herein. For example, the communications manager 620 may include a bit rate component 625, a transmission component 630, a codec component 635, an identification component 640, a request component 645, or any combination thereof. Each of these components, or components or subcomponents thereof (e.g., one or more processors, one or more memories), may communicate, directly or indirectly, with one another (e.g., via one or more buses).

The communications manager 620 may support wireless communications in accordance with examples as disclosed herein. The bit rate component 625 is capable of, configured to, or operable to support a means for receiving an indication of a first recommended bit rate for the device, the first communication path associated with a first communication path for a first network entity. In some examples, the bit rate component 625 is capable of, configured to, or operable to support a means for receiving an indication of a second recommended bit rate for the device, the second communication path associated with a second communication path for the first network entity or a second network entity. The transmission component 630 is capable of, configured to, or operable to support a means for transmitting, at a bit rate that is based on a combination of the first recommended bit rate and the second recommended bit rate, data associated with an application executed by the device.

In some examples, transmitting the data at the bit rate includes transmitting one subset of the data at a second bit rate over a third communication path between the device and a UE, the second bit rate based on the second recommended bit rate.

In some examples, transmitting the data at the bit rate further includes transmitting another subset of the data at a first bit rate over the first communication path for the first network entity, the first bit rate based on the first recommended bit rate.

In some examples, the identification component 640 is capable of, configured to, or operable to support a means for determining that the first recommended bit rate is for the first communication path based on a first identifier associated with the indication of the first recommended bit rate. In some examples, the identification component 640 is capable of, configured to, or operable to support a means for determining that the second recommended bit rate is for the second communication path based on a second identifier associated with the indication of the second recommended bit rate.

In some examples, the identification component 640 is capable of, configured to, or operable to support a means for determining that the first recommended bit rate is for the first communication path based on a bit associated with the indication of the first recommended bit rate.

In some examples, the indication of the first recommended bit rate and the indication of the second recommended bit rate are received by the device from the first network entity.

In some examples, the indication of the first recommended bit rate is received by the device from the first network entity. In some examples, the indication of the second recommended bit rate is received by the device from the UE.

In some examples, the request component 645 is capable of, configured to, or operable to support a means for transmitting a request for the second recommended bit rate based on the UE acting as a relay, between the device and the first network entity, for data associated with the application.

In some examples, the first recommended bit rate and the second recommended bit rate are both included in a set of recommended bit rates that are each associated with a respective index from among a set of respective indices. In some examples, the indication of the first recommended bit rate is a first index from among the set of respective indices. In some examples, the indication of the second recommended bit rate is a second index from among the set of respective indices.

In some examples, to support receiving the indication of the first recommended bit rate and receiving the indication of the second recommended bit rate, the bit rate component 625 is capable of, configured to, or operable to support a means for receiving a single index associated with both the first recommended bit rate and the second recommended bit rate.

In some examples, the indication of the first recommended bit rate is included in a first message and the indication of the second recommended bit rate is included in a second message.

In some examples, the indication of the first recommended bit rate and the indication of the second recommended bit rate are included in a same message.

In some examples, the device is a server and the first communication path is between a first UE and the first network entity. In some examples, the second communication path is between a second UE and the first network entity. In some examples, the data is transmitted at the bit rate over a third communication path between the server and the first network entity.

In some examples, the codec component 635 is capable of, configured to, or operable to support a means for selecting a codec rate for the application based on the combination of the first recommended bit rate and the second recommended bit rate, where the bit rate is in accordance with the codec rate.

In some examples, the device is a UE and the first communication path is between the UE and a first transmission reception point (TRP) associated with the first network entity. In some examples, the second communication path is between the UE and a second TRP associated with the first network entity or the second network entity.

In some examples, the device is a UE and the first communication path is via a first beam between the UE and the first network entity. In some examples, the second communication path is via a second beam between the UE and the first network entity or the second network entity.

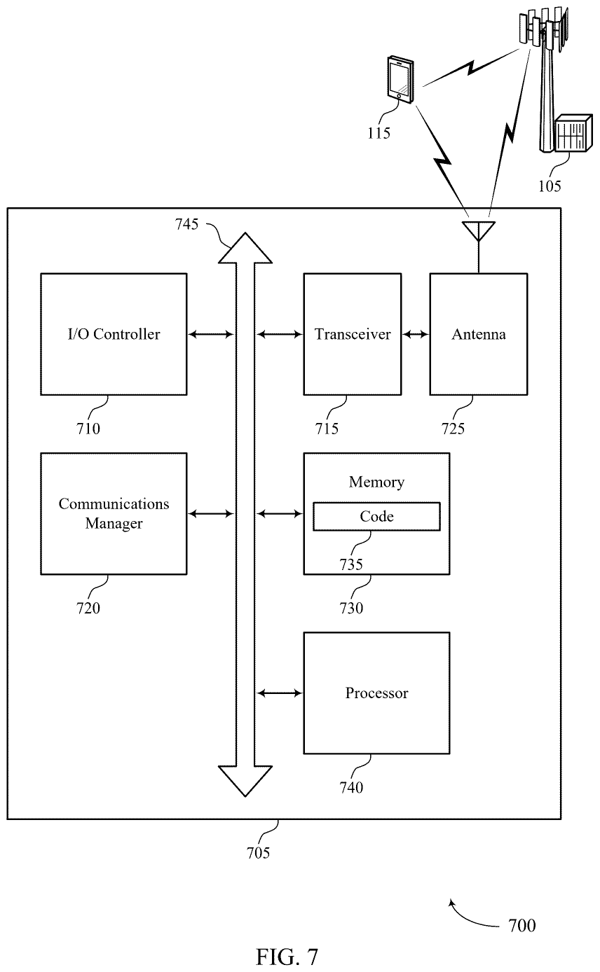

FIG. 7 shows a diagram of a system 700 including a device 705 that supports bit rate selection in a wireless communications system in accordance with one or more aspects of the present disclosure. The device 705 may be an example of or include components of a device 405, a device 505, or a UE 115 as described herein. The device 705 may communicate (e.g., wirelessly) with one or more other devices (e.g., network entities 105, UEs 115, or a combination thereof). The device 705 may include components for bi-directional voice and data communications including components for transmitting and receiving communications, such as a communications manager 720, an input/output (I/O) controller, such as an I/O controller 710, a transceiver 715, one or more antennas 725, at least one memory 730, code 735, and at least one processor 740. These components may be in electronic communication or otherwise coupled (e.g., operatively, communicatively, functionally, electronically, electrically) via one or more buses (e.g., a bus 745).

The I/O controller 710 may manage input and output signals for the device 705. The I/O controller 710 may also manage peripherals not integrated into the device 705. In some cases, the I/O controller 710 may represent a physical connection or port to an external peripheral. In some cases, the I/O controller 710 may utilize an operating system such as iOS®, ANDROID®, MS-DOS®, MS-WINDOWS®, OS/2®, UNIX®, LINUX®, or another known operating system. Additionally, or alternatively, the I/O controller 710 may represent or interact with a modem, a keyboard, a mouse, a touchscreen, or a similar device. In some cases, the I/O controller 710 may be implemented as part of one or more processors, such as the at least one processor 740. In some cases, a user may interact with the device 705 via the I/O controller 710 or via hardware components controlled by the I/O controller 710.

In some cases, the device 705 may include a single antenna. However, in some other cases, the device 705 may have more than one antenna, which may be capable of concurrently transmitting or receiving multiple wireless transmissions. The transceiver 715 may communicate bi-directionally via the one or more antennas 725 using wired or wireless links as described herein. For example, the transceiver 715 may represent a wireless transceiver and may communicate bi-directionally with another wireless transceiver. The transceiver 715 may also include a modem to modulate the packets, to provide the modulated packets to one or more antennas 725 for transmission, and to demodulate packets received from the one or more antennas 725. The transceiver 715, or the transceiver 715 and one or more antennas 725, may be an example of a transmitter 415, a transmitter 515, a receiver 410, a receiver 510, or any combination thereof or component thereof, as described herein.

The at least one memory 730 may include random access memory (RAM) and read-only memory (ROM). The at least one memory 730 may store computer-readable, computer-executable, or processor-executable code, such as the code 735. The code 735 may include instructions that, when executed by the at least one processor 740, cause the device 705 to perform various functions described herein. The code 735 may be stored in a non-transitory computer-readable medium such as system memory or another type of memory. In some cases, the code 735 may not be directly executable by the at least one processor 740 but may cause a computer (e.g., when compiled and executed) to perform functions described herein. In some cases, the at least one memory 730 may include, among other things, a basic I/O system (BIOS) which may control basic hardware or software operation such as the interaction with peripheral components or devices.

The at least one processor 740 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 740 may be configured to operate a memory array using a memory controller. In some other cases, a memory controller may be integrated into the at least one processor 740. The at least one processor 740 may be configured to execute computer-readable instructions stored in a memory (e.g., the at least one memory 730) to cause the device 705 to perform various functions (e.g., functions or tasks supporting bit rate selection in a wireless communications system). For example, the device 705 or a component of the device 705 may include at least one processor 740 and at least one memory 730 coupled with or to the at least one processor 740, the at least one processor 740 and the at least one memory 730 configured to perform various functions described herein.

In some examples, the at least one processor 740 may include multiple processors and the at least one memory 730 may include multiple memories. One or more of the multiple processors may be coupled with one or more of the multiple memories, which may, individually or collectively, be configured to perform various functions described herein. In some examples, the at least one processor 740 may be a component of a processing system, which may refer to a system (such as a series) of machines, circuitry (including, for example, one or both of processor circuitry (which may include the at least one processor 740) and memory circuitry (which may include the at least one memory 730)), or components, that receives or obtains inputs and processes the inputs to produce, generate, or obtain a set of outputs. The processing system may be configured to perform one or more of the functions described herein. For example, the at least one processor 740 or a processing system including the at least one processor 740 may be configured to, configurable to, or operable to cause the device 705 to perform one or more of the functions described herein. Further, as described herein, being “configured to,” being “configurable to,” and being “operable to” may be used interchangeably and may be associated with a capability, when executing code 735 (e.g., processor-executable code) stored in the at least one memory 730 or otherwise, to perform one or more of the functions described herein.

The communications manager 720 may support wireless communications in accordance with examples as disclosed herein. For example, the communications manager 720 is capable of, configured to, or operable to support a means for receiving an indication of a first recommended bit rate for a first communication path for the device, the first communication path associated with a first network entity. The communications manager 720 is capable of, configured to, or operable to support a means for receiving an indication of a second recommended bit rate for the device, the second communication path associated with a second communication path for the first network entity or a second network entity. The communications manager 720 is capable of, configured to, or operable to support a means for transmitting, at a bit rate that is based on a combination of the first recommended bit rate and the second recommended bit rate, data associated with an application executed by the device.

By including or configuring the communications manager 720 in accordance with examples as described herein, the device 705 may support techniques for more efficient utilization of communication resources and improved coordination between devices.

In some examples, the communications manager 720 may be configured to perform various operations (e.g., receiving, monitoring, transmitting) using or otherwise in cooperation with the transceiver 715, the one or more antennas 725, or any combination thereof. Although the communications manager 720 is illustrated as a separate component, in some examples, one or more functions described with reference to the communications manager 720 may be supported by or performed by the at least one processor 740, the at least one memory 730, the code 735, or any combination thereof. For example, the code 735 may include instructions executable by the at least one processor 740 to cause the device 705 to perform various aspects of bit rate selection in a wireless communications system as described herein, or the at least one processor 740 and the at least one memory 730 may be otherwise configured to, individually or collectively, perform or support such operations.

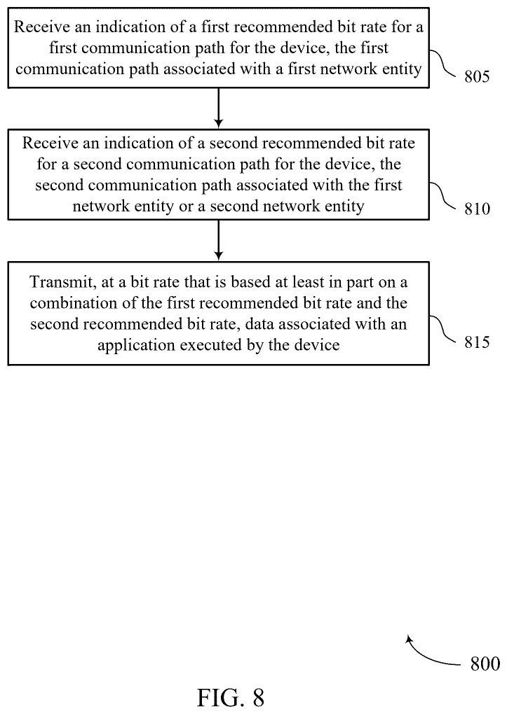

FIG. 8 shows a flowchart illustrating a method 800 that supports bit rate selection in a wireless communications system in accordance with one or more aspects of the present disclosure. The operations of the method 800 may be implemented by a UE or its components as described herein. For example, the operations of the method 800 may be performed by a UE 115 as described with reference to FIGS. 1 through 7. In some examples, a UE may execute a set of instructions to control the functional elements of the UE to perform the described functions. Additionally, or alternatively, the UE may perform aspects of the described functions using special-purpose hardware.

At 805, the method may include receiving an indication of a first recommended bit rate for a first communication path for the device, the first communication path associated with a first network entity. The operations of 805 may be performed in accordance with examples as disclosed herein. In some examples, aspects of the operations of 805 may be performed by a bit rate component 625 as described with reference to FIG. 6.

At 810, the method may include receiving an indication of a second recommended bit rate for the device, the second communication path associated with a second communication path for the first network entity or a second network entity. The operations of 810 may be performed in accordance with examples as disclosed herein. In some examples, aspects of the operations of 810 may be performed by a bit rate component 625 as described with reference to FIG. 6.

At 815, the method may include transmitting, at a bit rate that is based at least in part on a combination of the first recommended bit rate and the second recommended bit rate, data associated with an application executed by the device. The operations of 815 may be performed in accordance with examples as disclosed herein. In some examples, aspects of the operations of 815 may be performed by a transmission component 630 as described with reference to FIG. 6.

The following provides an overview of aspects of the present disclosure:

Aspect 1: A method for wireless communications at a device, comprising: receiving an indication of a first recommended bit rate for a first communication path for the device, the first communication path associated with a first network entity; receiving an indication of a second recommended bit rate for a second communication path for the device, the second communication path associated with the first network entity or a second network entity; and transmitting, at a bit rate that is based at least in part on a combination of the first recommended bit rate and the second recommended bit rate, data associated with an application executed by the device.

Aspect 2: The method of aspect 1, wherein transmitting the data at the bit rate comprises transmitting one subset of the data at a second bit rate over a third communication path between the device and a UE, the second bit rate based at least in part on the second recommended bit rate.

Aspect 3: The method of aspect 2, wherein transmitting the data at the bit rate further comprises transmitting another subset of the data at a first bit rate over the first communication path for the first network entity, the first bit rate based at least in part on the first recommended bit rate, and the bit rate comprises a combination of the first bit rate and the second bit rate.

Aspect 4: The method of any of aspects 2 through 3, further comprising: determining that the first recommended bit rate is for the first communication path based at least in part on a first identifier associated with the indication of the first recommended bit rate; and determining that the second recommended bit rate is for the second communication path based at least in part on a second identifier associated with the indication of the second recommended bit rate.

Aspect 5: The method of any of aspects 2 through 4, further comprising: determining that the first recommended bit rate is for the first communication path based at least in part on a bit associated with the indication of the first recommended bit rate.

Aspect 6: The method of any of aspects 2 through 5, wherein the indication of the first recommended bit rate and the indication of the second recommended bit rate are received by the device from the first network entity.

Aspect 7: The method of any of aspects 2 through 6, wherein the indication of the first recommended bit rate is received by the device from the first network entity, and the indication of the second recommended bit rate is received by the device from the UE.

Aspect 8: The method of any of aspects 2 through 7, further comprising: transmitting a request for the second recommended bit rate based at least in part on the UE acting as a relay, between the device and the first network entity, for data associated with the application.

Aspect 9: The method of any of aspects 2 through 8, wherein the first recommended bit rate and the second recommended bit rate are both included in a set of recommended bit rates that are each associated with a respective index from among a set of respective indices, the indication of the first recommended bit rate is a first index from among the set of respective indices, and the indication of the second recommended bit rate is a second index from among the set of respective indices.

Aspect 10: The method of any of aspects 2 through 9, wherein receiving the indication of the first recommended bit rate and receiving the indication of the second recommended bit rate comprises: receiving a single index associated with both the first recommended bit rate and the second recommended bit rate.

Aspect 11: The method of any of aspects 2 through 10, wherein the indication of the first recommended bit rate is included in a first message and the indication of the second recommended bit rate is included in a second message.

Aspect 12: The method of any of aspects 2 through 11, wherein the indication of the first recommended bit rate and the indication of the second recommended bit rate are included in a same message.

Aspect 13: The method of any of aspects 1 through 12, wherein the device is a server and the first communication path is between a first UE and the first network entity, the second communication path is between a second UE and the first network entity, and the data is transmitted at the bit rate over a third communication path between the server and the first network entity.

Aspect 14: The method of any of aspects 1 through 13, further comprising: selecting a codec rate for the application based at least in part on the combination of the first recommended bit rate and the second recommended bit rate, wherein the bit rate is in accordance with the codec rate.

Aspect 15: The method of any of aspects 1 through 14, wherein the device is a UE and the first communication path is between the UE and a first transmission reception point (TRP) associated with the first network entity, and the second communication path is between the UE and a second TRP associated with the first network entity or the second network entity.

Aspect 16: The method of any of aspects 1 through 15, wherein the device is a UE and the first communication path is via a first beam between the UE and the first network entity, and the second communication path is via a second beam between the UE and the first network entity or the second network entity.

Aspect 17: A device for wireless communications, comprising one or more memories storing processor-executable code, and one or more processors coupled with the one or more memories (e.g., operatively, communicatively, functionally, electronically, or electrically) and individually or collectively operable to execute the code (e.g., directly, indirectly, after pre-processing, without pre-processing) to cause the device to perform a method of any of aspects 1 through 16.

Aspect 18: A device for wireless communications, comprising at least one means for performing a method of any of aspects 1 through 16.

Aspect 19: A non-transitory computer-readable medium storing code for wireless communications, the code comprising instructions executable by one or more processors (e.g., directly, indirectly, after pre-processing, without pre-processing) to perform a method of any of aspects 1 through 16.

It should be noted that the methods described herein describe possible implementations. The operations and the steps may be rearranged or otherwise modified and other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein. Components within a wireless communication system may be coupled (for example, operatively, communicatively, functionally, electronically, and/or electrically) to each other.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, a graphics processing unit (GPU), a neural processing unit (NPU), an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, or any combination thereof. Software shall be construed broadly to mean instructions, instruction sets, code, code segments, program code, programs, subprograms, software modules, applications, software applications, software packages, routines, subroutines, objects, executables, threads of execution, procedures, or functions, whether referred to as software, firmware, middleware, microcode, hardware description language, or otherwise. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, phase change memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk, and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., including a list of items prefaced by a phrase such as “at least one of” or “one or more of”) indicates an inclusive list such that, for example, a list of at least one of A, B, or C means, e.g., A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.” As used herein, the term “and/or,” when used in a list of two or more items, means that any one of the listed items can be employed by itself, or any combination of two or more of the listed items can be employed. For example, if a composition is described as containing components A, B, and/or C, the composition can contain A alone; B alone; C alone; A and B in combination; A and C in combination; B and C in combination; or A, B, and C in combination.

As used herein, including in the claims, the article “a” before a noun is open-ended and understood to refer to “at least one” of those nouns or “one or more” of those nouns. Thus, the terms “a,” “at least one,” “one or more,” and “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” or “identify” or “identifying” encompasses a variety of actions and, therefore, “determining” or “identifying” can include calculating, computing, processing, deriving, investigating, looking up (such as via looking up in a table, a database or another data structure), ascertaining and the like. Also, “determining” or “identifying” can include receiving (such as receiving information or signaling, e.g., receiving information or signaling for determining, receiving information or signaling for identifying), accessing (such as accessing data in a memory, or accessing information) and the like. Also, “determining” or “identifying” can include resolving, obtaining, selecting, choosing, establishing and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label or other subsequent reference label.

The description set forth herein, in connection with the appended drawings, describes example configurations and does not represent all the examples that may be implemented or that are within the scope of the claims. The term “example” used herein means “serving as an example, instance, or illustration” and not “preferred” or “advantageous over other examples.” The detailed description includes specific details for the purpose of providing an understanding of the described techniques. These techniques, however, may be practiced without these specific details. In some figures, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A device, comprising:
one or more memories storing processor-executable code; and
one or more processors coupled with the one or more memories and individually or collectively operable to execute the code to cause the device to:
receive an indication of a first recommended bit rate for a first communication path for the device, the first communication path associated with a first network entity;
receive an indication of a second recommended bit rate for a second communication path for the device, the second communication path associated with the first network entity or a second network entity; and
transmit, at a bit rate that is based at least in part on a combination of the first recommended bit rate and the second recommended bit rate, data associated with an application executed by the device.

2. The device of claim 1, wherein, to transmit the data at the bit rate, the one or more processors are individually or collectively operable to execute the code to cause the device to:
transmit one subset of the data at a second bit rate over a third communication path between the device and a user equipment (UE), the second bit rate based at least in part on the second recommended bit rate.

3. The device of claim 2, wherein, to transmit the data at the bit rate, the one or more processors are individually or collectively further operable to execute the code to cause the device to:
transmit another subset of the data at a first bit rate over the first communication path for the first network entity, the first bit rate based at least in part on the first recommended bit rate.

4. The device of claim 2, wherein the one or more processors are individually or collectively further operable to execute the code to cause the device to:
determine that the first recommended bit rate is for the first communication path based at least in part on a first identifier associated with the indication of the first recommended bit rate; and
determine that the second recommended bit rate is for the second communication path based at least in part on a second identifier associated with the indication of the second recommended bit rate.

5. The device of claim 2, wherein the one or more processors are individually or collectively further operable to execute the code to cause the device to:
determine that the first recommended bit rate is for the first communication path based at least in part on a bit associated with the indication of the first recommended bit rate.

6. The device of claim 2, wherein the one or more processors are individually or collectively further operable to execute the code to cause the device to receive the indication of the first recommended bit rate and the indication of the second recommended bit rate from the first network entity.

7. The device of claim 2, wherein the one or more processors are individually or collectively further operable to execute the code to cause the device to receive the indication of the first recommended bit rate from the first network entity and receive the indication of the second recommended bit rate from the UE.

8. The device of claim 2, wherein the one or more processors are individually or collectively further operable to execute the code to cause the device to:
transmit a request for the second recommended bit rate based at least in part on the UE acting as a relay, between the device and the first network entity, for data associated with the application.

9. The device of claim 2, wherein the first recommended bit rate and the second recommended bit rate are both included in a set of recommended bit rates that are each associated with a respective index from among a set of respective indices, wherein the indication of the first recommended bit rate is a first index from among the set of respective indices, and wherein the indication of the second recommended bit rate is a second index from among the set of respective indices.

10. The device of claim 2, wherein, to receive the indication of the first recommended bit rate and receive the indication of the second recommended bit rate, the one or more processors are individually or collectively operable to execute the code to cause the device to:
receive a single index associated with both the first recommended bit rate and the second recommended bit rate.

11. The device of claim 2, wherein the indication of the first recommended bit rate is included in a first message and the indication of the second recommended bit rate is included in a second message.

12. The device of claim 2, wherein the indication of the first recommended bit rate and the indication of the second recommended bit rate are included in a same message.

13. The device of claim 1, wherein the device is a server and the first communication path is between a first user equipment (UE) and the first network entity, wherein the second communication path is between a second UE and the first network entity, and wherein the data is transmitted at the bit rate over a third communication path between the server and the first network entity.

14. The device of claim 1, wherein the one or more processors are individually or collectively further operable to execute the code to cause the device to:
select a codec rate for the application based at least in part on the combination of the first recommended bit rate and the second recommended bit rate, wherein the bit rate is in accordance with the codec rate.

15. The device of claim 1, wherein the device is a user equipment (UE) and the first communication path is between the UE and a first transmission reception point (TRP) associated with the first network entity, and wherein the second communication path is between the UE and a second TRP associated with the first network entity or the second network entity.

16. The device of claim 1, wherein the device is a user equipment (UE) and the first communication path is via a first beam between the UE and the first network entity, and wherein the second communication path is via a second beam between the UE and the first network entity or the second network entity.

17. A method for wireless communications at a device, comprising:
receiving an indication of a first recommended bit rate for a first communication path for the device, the first communication path associated with a first network entity;
receiving an indication of a second recommended bit rate for a second communication path for the device, the second communication path associated with the first network entity or a second network entity; and
transmit, at a bit rate that is based at least in part on a combination of the first recommended bit rate and the second recommended bit rate, data associated with an application executed by the device.

18. The method of claim 17, wherein transmitting the data at the bit rate comprises transmitting one subset of the data at a second bit rate over a third communication path between the device and a user equipment (UE), the second bit rate based at least in part on the second recommended bit rate.

19. The method of claim 18, wherein transmitting the data at the bit rate further comprises transmitting another subset of the data at a first bit rate over the first communication path for the first network entity, the first bit rate based at least in part on the first recommended bit rate.

20. A non-transitory computer-readable medium storing code for wireless communication, the code comprising instructions executable by at least one processor to:
receive an indication of a first recommended bit rate for a first communication path for a device, the first communication path associated with a first network entity;
receive an indication of a second recommended bit rate for a second communication path for the device, the second communication path associated with the first network entity or a second network entity; and
transmit, at a bit rate that is based at least in part on a combination of the first recommended bit rate and the second recommended bit rate, data associated with an application executed by the device.
